(19) United States
(12) Patent Application Publication
(10) Pub. No.: US 2017/0216139 A1
(43) Pub. Date: Aug. 3, 2017

(54) GRAVITY INFUSION IV BAG

(71) Applicant: MONDIALE TECHNOLOGIES LIMITED, Mount Eden Auckland, OT (NZ)

(72) Inventor: Raymond John AVERY, Mount Eden Auckland (NZ)

(73) Assignee: MONDIALE TECHNOLOGIES LIMITED, Mount Eden Auckland, OT (NZ)

(21) Appl. No.: 15/515,428

(22) PCT Filed: Sep. 9, 2015
(86) PCT No.: PCT/NZ2015/050136

§ 371 Date: Mar. 29, 2017

(30) Foreign Application Priority Data
Oct. 2, 2014 (NZ) 700625

(51) Int. Cl. A61J 1/10; A61J 1/14

(52) U.S. Cl. CPC A61J 1/10; A61J 1/1462; A61J 1/1493; A61J 1/1475

(57) ABSTRACT

A gravity infusion IV bag having an elastic suspension arrangement with one or more suspension elements attached at a top end of the bag section and arranged to be hung from a support such that, as fluid flows from the outlet, the weight of the bag section reduces and the elastic suspension arrangement contracts to raise the bag section relative to the support. The one or more suspension elements may be formed from styrene-ethylene-butadiene-styrene (SEBS) and have a 100% Young's modulus in the range 80-120 psi.

### FIELD OF THE INVENTION

The invention relates to a gravity infusion IV bag. In particular, the invention relates to a gravity infusion IV bag including an elastic suspension arrangement.

### BACKGROUND TO THE INVENTION

The administration of medicines, rehydration fluids and nutritional formulations by intravenous (IV) infusion is one of the most common medical procedures employed worldwide.

In gravity IV infusion (also known as a gravity drip), the IV bag is placed above the level of the patient, with gravity causing IV fluid to flow out from the IV bag. Typically in first world hospitals gravity infusion sets are used for the administration of rehydration fluids and non-critical therapeutic treatments. In the developing world gravity infusion is typically used for all IV clinical applications including rehydration, drug administration and the administration of parental nutrition.

There are a number of contributing factors which may adversely effect the accuracy of gravity IV infusion sets:

1. The hydrostatic pressure being applied to the IV line constantly decreases as the IV bag empties.

2. IV tubing physical characteristics and changes in those characteristics over time, including changes caused by cold flow creep.

3. Roller clamp design and construction quality.

In the developed world microprocessor controlled IV pumps have been suggested to provide accurate IV infusion. However microprocessor controlled IV systems require significant ongoing cost centre infrastructures to service and maintain (e.g. recalibrate) the units and to train nursing staff in their use. In addition the high costs of these goes financially beyond the reach of most of hospitals in the developing world setting. Gravity IV infusion using an IV bag and standard IV infusion remains the most common method of administering IV infusion therapy. The inherent inaccuracy of gravity infusion systems means that patients receiving gravity IV infusion treatment may not receive the correct dose of the prescribed therapeutic medicine.

The Applicant's PCT/NZ2007/000324, the entire contents of which are hereby incorporated by reference herein, discloses a fluid controller that provides a significant improvement in accuracy over traditional roller clamps.

One prior attempt to address the changing hydrostatic pressure was the IV2 Flow regulator from Varori International Ltd. That device is described in the specification of U.S. Pat. No. 7,001,365, the entire contents of which are hereby incorporated by reference herein. Such a device is inserted into the flow conduit between the fluid source (usually an IV bag) and the flow controller.

A further attempt to address the changing hydrostatic pressure was proposed in U.S.2007/0235623, which discloses hanging an IV bag from, a support by a rubber band, spring or the like. This is intended to maintain the fluid level at a substantially constant height. The rubber band or spring retracts as the bag empties. An earlier device using a spring device to raise the IV bag is described in U.S. Pat. No. 2,771,878.

U.S.2007/0235623 proposes that the IV bag be hung either from a spring or from an elastic material such as silicone or latex. The materials described in U.S.2007/0235623 would not, in the Applicant's view, be suitable to provide the correct compensating force to maintain a static fluid level as the IV bag empties.

Reference to any prior art in this specification does not constitute an admission that such prior art forms part of the common general knowledge.

It is an object of the invention to provide an improved IV Bag which overcomes or at least ameliorates some or all of the above shortcomings, or to at least provide the public with a useful choice.

### SUMMARY OF THE INVENTION

In a first aspect the invention provides a gravity infusion IV bag comprising: a bag section including a closed chamber configured, in use, to hold an IV fluid, at least one outlet through which, in use, IV fluid may flow; and an elastic suspension arrangement comprising one or more suspension elements formed from styrene-ethylene-butadiene-styrene (SEBS), attached at a top end of the bag section and arranged to be hung from a support; wherein, in use, as fluid flows from the outlet, the weight of the bag section reduces and the elastic suspension arrangement contracts to raise the bag section relative to the support.

Preferably the elastic suspension arrangement contracts in direct proportion to the reduction of the weight of the bag section, such that a substantially constant hydrostatic pressure is maintained at the outlet.

Preferably the bag section is formed from one or more materials selected from the group comprising: pharmaceutical grade polypropylene (PP) and styrene ethylene butadiene styrene (SEBS), ethylene vinyl acetate (EVAM), polypropylene, and copolyester ether.

Preferably the elastic suspension arrangement is thermally welded to the bag section.

Preferably the elastic suspension arrangement is integrally formed with the bag section.

Preferably the elastic suspension arrangement is attached to the bag section during forming of seals in the bag section.

Preferably the elastic suspension arrangement forms a loop.

Preferably the elastic suspension arrangement is a cord.

In another aspect the invention provides a gravity infusion IV bag comprising: a bag section including a closed chamber configured, in use, to hold an IV fluid, at least one outlet through which, in use, IV fluid may flow; and an elastic suspension arrangement comprising one or more suspension elements with a 100% Young's modulus in the range 80-120 psi attached at a top end of the bag section and arranged to be hung from a support; wherein, in use, as fluid flows from the outlet, the weight of the bag section reduces and the elastic suspension arrangement contracts to raise the bag section relative to the support.

Preferably the one or more suspension elements have a Shore A hardness between 32-38.

Preferably the one or more suspension elements have a tensile strength in the range 1800-2400 psi.

### BRIEF DESCRIPTION OF THE DRAWINGS

The invention will now be described by way of example only, with reference to the accompanying drawings, in which:

FIG. 1 shows a front view of an IV bag according to an embodiment of the present invention;

FIGS. 2a-2c show three positions of the IV bag of FIG. 1 as the level of fluid inside the IV bag changes;

FIG. 3 shows the pressure heading effect comparison between a statically hung IV bag and one with elastic pressure heading compensation;

FIG. 4a shows a front view of an IV bag according to another embodiment of the present invention;

FIG. 4b shows a right side view of the IV bag of FIG. 4a;

FIG. 5a shows a front view of an IV bag according to another embodiment of the present invention;

FIG. 5b shows a right side view of the IV bag of FIG. 5a; and

FIG. 6 shows a front view of an IV bag according to another embodiment of the present invention.

### DETAILED DESCRIPTION

The invention relates to an improved IV bag for use in gravity IV infusion. In gravity IV infusion (also known as a gravity drip), the IV bag is placed above the level of the patient, with gravity causing fluid flow out of the IV bag, through a tube into the blood stream of the patient. The IV bag is often hung on a stand.

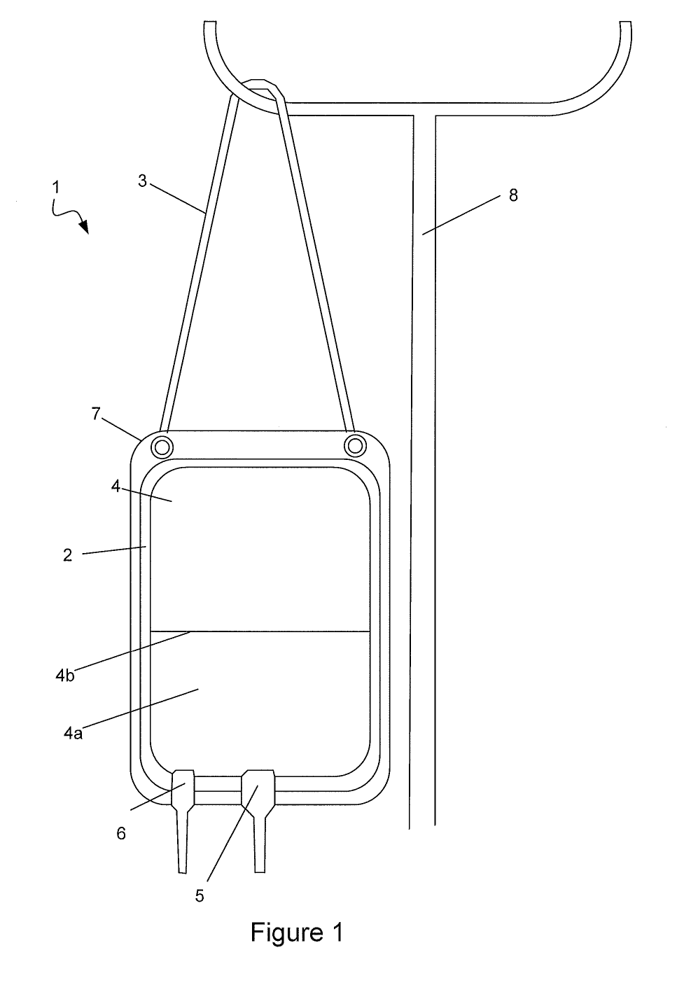

FIG. 1 shows a front view of a gravity infusion IV bag 1 according to an embodiment of the present invention. The gravity infusion IV bag 1 includes a bag section 2 and an elastic suspension arrangement 3.

The bag section 2 includes a closed chamber 4, which is configured to hold IV fluid 4a. The bag section 2 also includes at least one outlet 5 through which IV fluid 4a may flow. The bag section 2 may also optionally include a needle port 6.

The elastic suspension arrangement 3 is attached at a top end 7 of the bag section 2. The elastic suspension arrangement 3 is arranged to be hung from a support 8. The support 8 may be any suitable support arrangement, for example a wheelable standard IV bag stand with a raised loop or hook from which IV bags are hung. When the elastic suspension arrangement 3 is hung on the support 8 it extends under the weight of the bag contents (i.e. IV fluid).

The elastic suspension arrangement 3 is configured to contract to raise the bag section 2 as fluid 4a flows from the outlet 5 and the weight of the bag section 2 reduces. The result is that a substantially constant hydrostatic pressure is maintained at the outlet 5.

Preferably, the elastic suspension arrangement 3 is configured to contract in direct proportion to the reduction of the weight of the bag section, such that a substantially constant hydrostatic pressure is maintained in the bag section 2. The result of this is that the rate at which fluid 4a flows from the outlet 5 will remain substantially constant, so that a patient receives a substantially constant dose of the fluid 4.

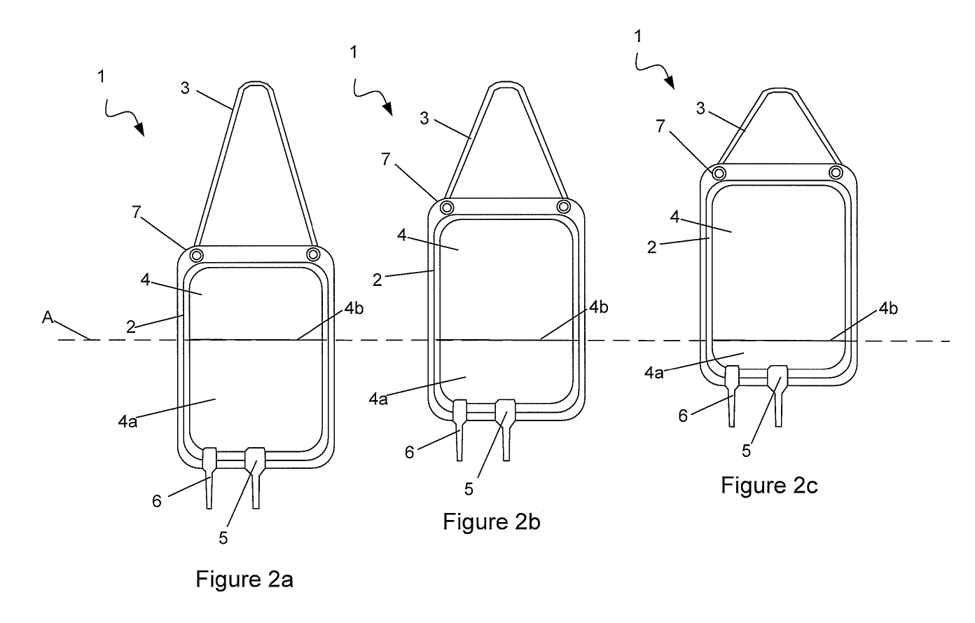

FIGS. 2a-2c show the IV bag of FIG. 1 as the level of fluid 4a inside the IV bag changes. As shown, the elastic suspension arrangement 3 contracts as the amount of IV fluid 4a in the IV bag reduces. This maintains the fluid level xx at a substantially constant level indicated by the dashed line xx. FIG. 2a shows an IV bag filled approximately half way with IV fluid 4. The level of fluid 4a in FIG. 2a is approximately twice that of the level of fluid 4a in FIG. 2b, which in turn contains approximately twice the level of fluid 4a of FIG. 2c. As the amount of fluid 4a in the IV bag reduces, the weight of the IV bag decreases, and this is accompanied by a decrease in the length of the suspension arrangement, which raises the level of the IV bag at an approximately proportional rate.

The elastic suspension arrangement 3 provides a force analogous to the spring force under Hooke's Law: F=k x. The force F needed to extend a spring by some distance x is proportional to that distance, where k is a constant factor characterising the stiffness of the spring. The force provided by a stretched elastic material is well understood and need not be described in detail in this specification.

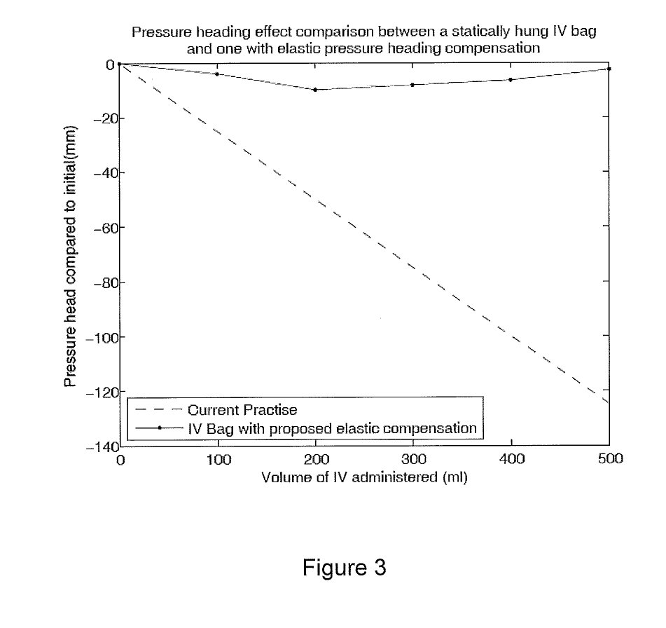

FIG. 3 shows the pressure heading effect comparison between a statically hung IV bag and a bag according to an embodiment of the present invention (an IV bag including an elastic suspension arrangement 3 according to the present invention). “Pressured head”, relates to the internal energy of IV fluid 4a due to the pressure exerted on the bag section 2.

The pressure head compared to the initial of a statically hung IV bag (shown by the dashed line labelled “current practice”) decreases at a relatively constant rate as IV fluid is administered. In contrast, an IV bag 2 including an elastic suspension arrangement 3 maintains the pressure head relatively constant.

In this application the elastic suspension arrangement is formed from a particular elastic material, and does not include coil or air springs or the like.

The elastic suspension arrangement is formed from styrene-ethylene-butadiene-styrene (SEBS). A suitable SEBS material provides the following chemical and physical characteristics:

| | |
|---|---|
| Tensile strength (psi) | 2100 |
| Ultimate Elongation | 90% |
| 100% modulus (psi) | 100 |
| 300% modulus (psi) | 195 |
| 500% modulus (psi) | 600 |
| Density (gm/cm3) | 0.88-0.92 |
| Melting temp (F.) | 380 Degrees |
| Hardness Durometer (Shore A) | 32-38 |
| Tear resistance | Good |
| Abrasion resistance | Good |

Preferably, the elastic suspension arrangement 3 can be gamma and ETO sterilised.

The gravity infusion IV bag may be made of any suitable material. Traditionally, IV bags have been manufactured from PVC, however due to the toxic nature of this material, preferably the IV bag is manufactured from a safe material other than PVC. Preferably, the IV bag comprises pharmaceutical grade polypropylene and a block co polymer of styrene ethylene butadiene and styrene (PP/SEBS).

Alternatively, the gravity infusion IV bag may comprises ethylene vinyl acetate (EVAM), polypropylene or copolyester ether. The invention is not limited in this respect.

By changing the cross sectional area of a (SEBS) cord manufactured using material with these characteristics it is possible to provide accurate constant hydrostatic control to a range of IV Bag sizes simply by varying the cross sectional area of the cord.

For example for a 1000 ml Bag of 0.9% Saline a SEBS cord measuring 3,5 mm in diameter will maintain a constant hydrostatic pressure, while a 2.5 mm diameter SEBS cord will maintain a constant hydrostatic pressure in a 500 ml bag of 0.9% saline.

Knowing the physical properties of different diameter SEBS cord it is possible to calculate the cross sectional area required to compensate for an IV Bag containing a specific volume and specific gravity ingredient according to the following equation.

Preferably, the length of elastic suspension arrangement 3, or the length of the suspension elements of the elastic suspension arrangement in an unextended state will be approximately the same length as the length of the bag section 2. In some embodiments the length of the suspension elements of the elastic suspension arrangement in an unextended state may be between 0.5 and 2 times the length of the bag section 2.

This length range keeps the maximum required extension of the suspension arrangement within reasonable limits, such that the material acts more nearly like a perfect spring. At greater extensions the modulus of elasticity may deviate outside of an acceptable range.

The height change required during draining of the IV bag section 2 is equal to the height of the bag section 2. That is, the height difference between a first extended state of the suspension arrangement 3 when the IV bag is full, and a second retracted state of the suspension arrangement 3 when the IV bag is empty, should be around the same as the physical height (i.e. dimension) of the IV bag. This allows the liquid surface within the bag section 2 to be maintained at the same height throughout.

It is also envisaged that there may be compositions other than SEBS that may be suitable materials for the suspension elements of the elastic suspension arrangement 3. In particular, materials having similar chemical and physical properties to those of SEBS as outlined above may be suitable. Suitable suspension elements have a 100% Young's modulus of approximately 80-120, preferably 90-110, ideally around 100 psi. Preferably, suspension elements will also have a Shore A hardness between 32-38 and a tensile strength of approximately 1800-2400 more preferably around 2000 to 2200, ideally around 2100 psi.

The elastic suspension arrangement 3 may be affixed to the bag during manufacture via any suitable mechanism. For example, it may be manufactured during the Form Fill Seal (FFS) IV bag manufacturing process or after the bag manufacturing process by thermo welding.

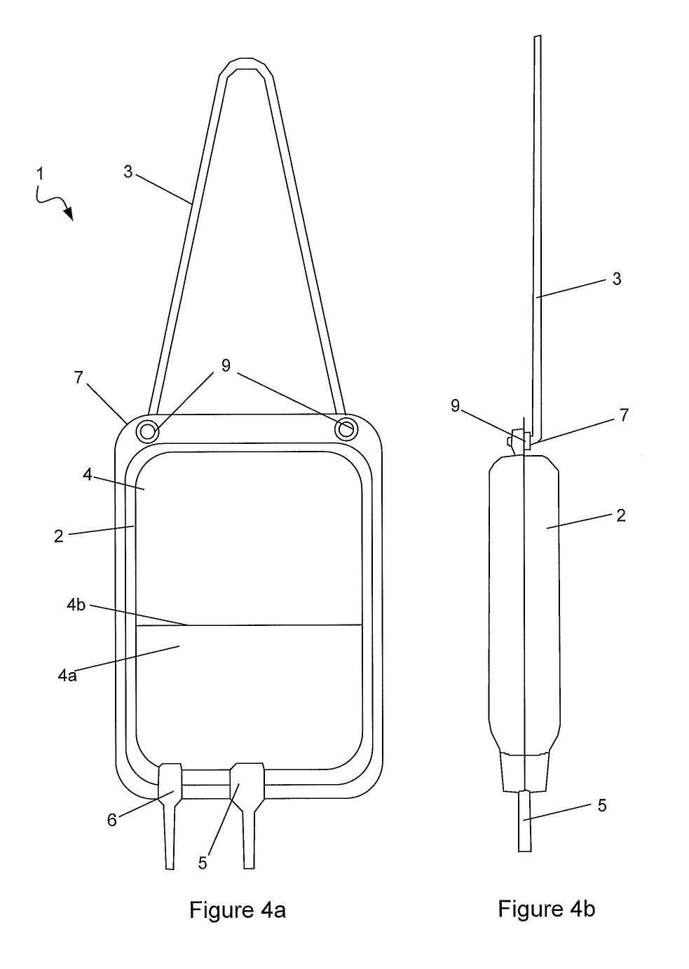

FIG. 4a shows a front view of an embodiment of the present invention in which the elastic suspension arrangement 3 connected to bag material via two apertures 9. FIG. 4b shows a side view of the embodiment of 4a, showing how the suspension arrangement goes through apertures 9 and is secured to the IV bag with a fastener 11.

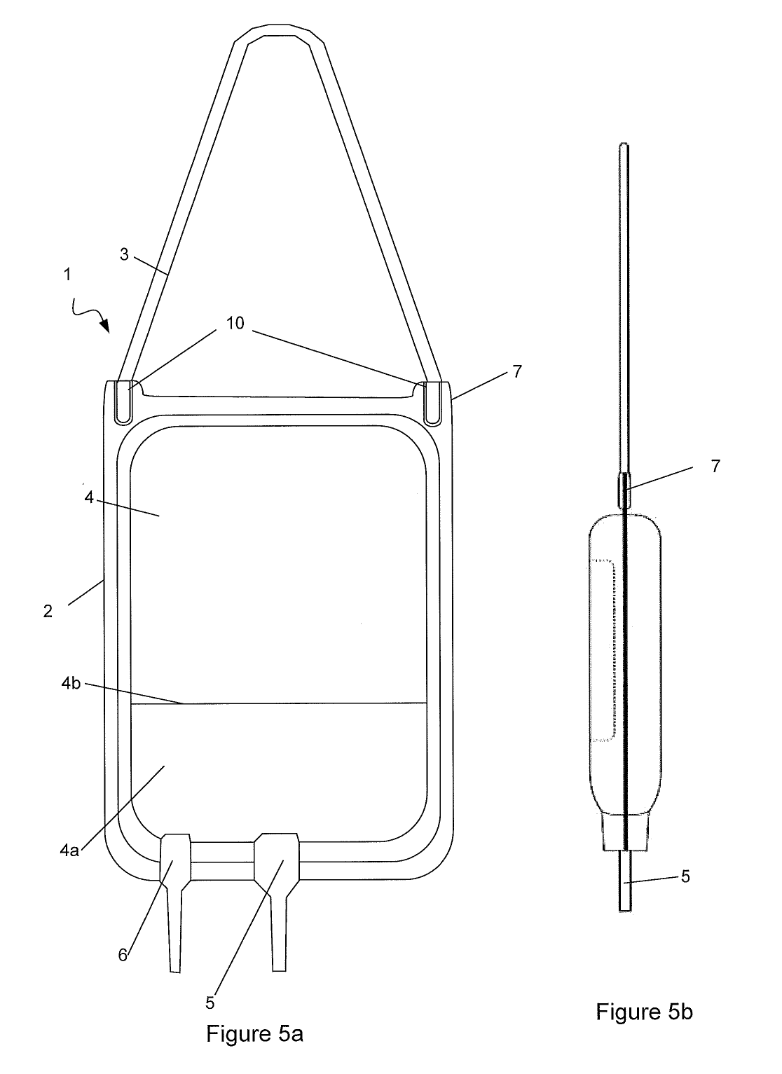

FIG. 5a shows a front view of an embodiment of the present invention in which the elastic suspension arrangement 3 is integrally formed into the IV bag, during Form Fill Seal (FFS). Seals 10 seal the elastic suspension arrangement 3 within the material of the bag section 2. FIG. 5b shows a side view of the embodiment of FIG. 5b. The thermal welding processes used in bag manufacture may form a welded connection between the SEBS elastic suspension arrangement 3 and the bag section 2.

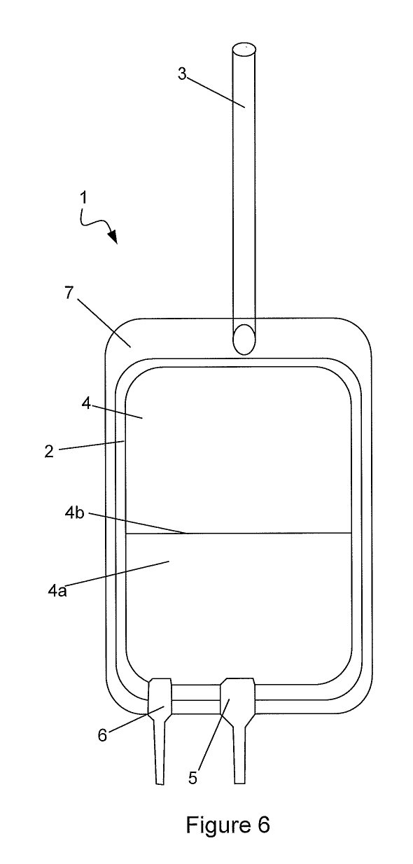

In FIGS. 1 and 2, the elastic suspension arrangement 3 forms a loop, which attaches to the top end 7 of the IV bag at the two ends of the elastic suspension arrangement, and can be hung on a stand from the midsection of the elastic suspension arrangement 3. However, the invention is not limited in this respect, and the elastic suspension arrangement 3 may have any suitable configuration. FIG. 6 shows an embodiment where the elastic suspension arrangement 3 is a cord which attaches to a top end 7 of the IV bag on one end, and to the stand (not shown) at its other end.

While the present invention has been illustrated by the description of the embodiments thereof, and while the embodiments have been described in detail, it is not the intention of the Applicant to restrict or in any way limit the scope of the appended claims to such detail. Further, the above embodiments may be implemented individually, or may be combined where compatible. Additional advantages and modifications, including combinations of the above embodiments, will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. A gravity infusion IV bag comprising:
a bag section including a closed chamber configured, in use, to hold an IV fluid, at least one outlet through which, in use, IV fluid may flow; and
an elastic suspension arrangement comprising one or more suspension elements formed from styrene-ethylene-butadiene-styrene (SEBS), attached at a top end of the bag section and arranged to be hung from a support;
wherein, in use, as fluid flows from the outlet, the weight of the bag section reduces and the elastic suspension arrangement contracts to raise the bag section relative to the support.

2. The gravity infusion IV bag of claim 1 wherein the elastic suspension arrangement contracts in direct proportion to the reduction of the weight of the bag section, such that a substantially constant hydrostatic pressure is maintained at the outlet.

3. The gravity infusion IV bag of claim 1 wherein the bag section is formed from one or more materials selected from the group comprising: pharmaceutical grade polypropylene (PP) and styrene ethylene butadiene styrene (SEBS), ethylene vinyl acetate (EVAM), polypropylene, and copolyester ether.

4. The gravity infusion IV bag of claim 1 wherein the elastic suspension arrangement is thermally welded to the bag section.

5. The gravity infusion IV bag of claim 1 wherein the elastic suspension arrangement is integrally formed with the bag section.

6. The gravity infusion IV bag of claim 1 wherein the elastic suspension arrangement is attached to the bag section during forming of seals in the bag section.

7. The gravity infusion IV bag of claim 1 wherein the elastic suspension arrangement forms a loop.

8. The gravity infusion IV bag of claim 1 wherein the elastic suspension arrangement is a cord.

9. A gravity infusion IV bag comprising:
a bag section including a closed chamber configured, in use, to hold an IV fluid, at least one outlet through which, in use, IV fluid may flow; and
an elastic suspension arrangement comprising one or more suspension elements with a 100% Young's modulus in the range 80-120 psi attached at a top end of the bag section and arranged to be hung from a support;
wherein, in use, as fluid flows from the outlet, the weight of the bag section reduces and the elastic suspension arrangement contracts to raise the bag section relative to the support.

10. The gravity infusion IV bag of claim 9 wherein the one or more suspension elements have a Shore A hardness between 32-38.

11. The gravity infusion IV bag of claim 9 wherein the one or more suspension elements have a tensile strength in the range 1800-2400 psi.
